(19) United States
(12) Patent Application Publication
(10) Pub. No.: US 2023/0310120 A1
(43) Pub. Date: Oct. 5, 2023

(54) FILM TENSIONING ELEMENT, METHOD FOR THE APPLICATION OF A FILM TENSIONING ELEMENT IN COMBINATION WITH THE SCAN HEAD OF A SCANNER, AS WELL AS METHOD FOR PRODUCING A FILM TENSIONING ELEMENT

(71) Applicant: Ivoclar Vivadent AG, Schaan (LI)

(72) Inventor: Markus Lichtensteiger, Montlingen (CH)

(21) Appl. No.: 18/190,408

(22) Filed: Mar. 27, 2023

(30) Foreign Application Priority Data
Mar. 29, 2022 (EP) 22165245.6

(51) Int. Cl. A61C 5/90; C08L 33/24; C08L 67/03; A61C 5/82

(52) U.S. Cl. CPC A61C 5/90; C08L 33/24; C08L 67/03; A61C 5/82; C08L 2203/02; C08L 2203/16

(57) ABSTRACT

A film tensioning element is provided for dental applications with a film extending between tensioning rings. The film has a modulus of elasticity of less than 2 KN/mm². The film is made of a tough plastic with a modulus of elasticity of more than 1 KN/mm², in particular of PP, or optionally of PA. The film tensioning element is manufactured together with the tensioning rings.

### CROSS-REFERENCE TO RELATED APPLICATIONS

This application claims priority to European Patent Application No. 22165245.6 filed on Mar. 29, 2022, the disclosure of which is incorporated herein by reference in its entirety.

### TECHNICAL FIELD

The invention relates to a film tensioning element and a method for the application of the film tensioning element.

### BACKGROUND

Such film tensioning elements have been used successfully for decades under the name OPTRAGATE®. They consist of a lip ring and a vestibular ring, between which a film extends. The shape resulting from this construction is essentially ring-shaped and allows the patient's lip area to be covered, thus providing hygienically perfect access to the patient's oral cavity.

To avoid allergic adverse effects, the film is typically designed to be latex-free.

An example of such a film tensioning element can be found in EP 3 708 112 A1 and corresponding U.S. Pat. No. 11,234,793, which US patent is hereby incorporated by reference in its entirety. The film must be able to adapt to quite different anatomical requirements. In order not to have to provide a multitude of different forms of film tensioning elements, a highly elastic elastomer is typically used for the film. This is typically injection molded onto the two aforementioned rings.

With this solution, it is possible, for example, to get by with only two sizes of film tensioning element, one size for adults and one size for children. In this way, inventory is kept to the necessary minimum.

Elastomers (TPE) exhibit significantly lower allergic reactions than latex. However, since as many as 15% of the population is prone to allergies, allergies also exist to these synthetic plastics.

Another problem when using TPE for the film is the high coefficient of static friction of the film. When the dentist inserts an instrument into the patient's mouth and the shaft of the instrument comes into contact with the film, it often sticks to the shaft. This leads to the so-called slip-stick effect. While scanning the vestibular space, this causes the scan to be interrupted or distorted and it may have to be repeated.

For the above reason, it has been proposed to coat the film on the oral side with a lubricant and on the lip side with an allergy-proof coating.

On the one hand, such coatings make the production of the film tensioning element more expensive, and they also make the disposal of this disposable product more problematic, since a total of four different materials (rings, film, inner coating, outer coating) are then used.

US 20230000602, 20220183791, 20190269312 are directed to film tensioning elements or mouth retraction devices and are hereby incorporated by reference in their entirety. US 20200315434 is directed to an intraoral scanning system and is hereby incorporated by reference in its entirety.

### SUMMARY

Therefore, the invention is based on the task of creating a film tensioning element, a method for the application of the film tensioning element, as well as a method for the production of a film tensioning element, which is inexpensive to produce and uncomplicated to handle.

According to the invention, it is intended to manufacture the film from a tough plastic whose modulus of elasticity is between 1 and 2 kilonewtons per square millimeter. Examples of tough plastics include, but are not limited to, polyolefins such as polypropylene or optionally polyamide, or a mixture thereof. These two plastics are not known to be allergenic. According to the invention, the film consists of only one material, namely the tough plastic, and does not have any coatings. Other examples of plastic materials useful herein include, but are not limited to, linear polyesters, such as polyethylene terephthalate (PET) and polyethylene naphthalate (PEN), or a mixture thereof

According to the invention, it is particularly advantageous that due to the suitable size measurements of the film tensioning element, only two sizes need to be used despite the use of a tough plastic for the films.

Investigations conducted in connection with the invention have shown that even when only one adult size and one child size were used, no complaints were made with regard to the fit. The uniform application of pressure or deformation of soft tissue is in no way perceived as unpleasant by patients, at least not in comparison with the machining of hard dental tissue, as is required for the application of dental restorations.

According to the invention, no slip-stick effect is observed when polypropylene and polyamide are used for the film. Therefore, it is ensured that a scan of the vestibular space can be performed without any problems, so that the overall treatment time is reduced compared to the prior art, which is convenient for both the dentist and the patient.

The scan can also be performed at a more precise elevation. For this purpose, the dentist deliberately places the shaft of the intraoral scanner against the film, for example, against the film resting on the patient's lower lip, and guides the scan head along the entire vestibular space at a constant height. According to the invention, the quality of the scan is thus also improved.

According to the invention, the film tensioning element is used as a support for the movement of the scan head.

According to the invention, the film tensioning element can also be produced in a particularly simple and efficient manner:

First of all, a mold with a patrix and a matrix is used for the production of the film. The mold is initially opened, and a product-shaped film extends somewhat tensioned between the patrix and the matrix.

Before closing the mold, while closing the mold and/or after closing the mold, negative pressure is applied to the patrix, which causes the film to be sucked in there. Alternatively or additionally, negative pressure or positive pressure can also be applied to the matrix in order to improve the contact of the film in the mold.

At the points where the rings are to be formed, ring-shaped cavities are provided, each in the shape of a ring. The material for the rings is injected at these points via injection-molding nozzles and injected onto the film.

What is particularly advantageous here is that the same material can surprisingly be used for the rings and the film. The difference in material thickness of 0.1 mm to 1 millimeter is sufficient to ensure the desired distribution of strength.

Preferably, both the rings and the film are made of polypropylene. The film has a constant thickness over its course and the rings have an oval or circular, but in any case rounded, structure in section.

A modified embodiment provides for the rings to taper towards the film. This avoids a jump in stiffness and the film can have a lower material thickness without the risk of tearing at this point.

Instead of polypropylene, a polyamide fabric can also be used for the film and polyamide for the rings, or a fabric made of polyolefin.

Preferably, a ring cavity is formed at the foot of the patrix and another at the head of the patrix. The first cavity is used for injecting the lip ring, and the second for injecting the vestibular ring.

With a suitable punching tool, the film on the head side of the patrix is now punched out immediately adjacent to the vestibular ring.

Punching can also be conducted when the injection molds are closed, as an annular punching knife cuts off the film adjacent to the cavity for the vestibular ring.

In either case, the result is a truncated cone-shaped film tensioning element that is particularly well suited for scanning in the patient's mouth.

It is preferable that a film tensioning element for dental applications is provided with a film which extends between tensioning rings, the film having a modulus of elasticity of less than 2 KN/mm², wherein the film is fabricated of a plastic, wherein the film tensioning element is produced together with the tensioning rings.

It is preferable that the plastic is a tough plastic having a modulus of elasticity of more than 1 KN/mm². It is preferable that the plastic is a polyolefin, a linear polyester or a mixture thereof. It is preferable that the polyolefin is a polypropylene, polyamide or a mixture thereof and wherein the linear polyester is polyethylene terephthalate (PET), polyethylene naphthalate (PEN), or a mixture thereof.

It is preferable that the tensioning rings are fabricated of the same plastic as the film and the tensioning rings are integral with the film.

It is preferable that the film has a coefficient of static friction, μ_{H}≤0.4, or in a range of 0.1 to 0.6 and a coefficient of gliding friction, μ_{G}≤0.35, or in a range of 0.1 to 0.6. It is preferable that the coefficient of static friction μ_{H} of the film and the coefficient of gliding friction μ_{G} of the film differ by less than 0.05.

It is preferable that the film tensioning element is designed as a tensioning dam or as a coffer dam and is intended for use in the mouth of a patient.

It is preferable that the film tensioning element is produced by a mold labelling or mold coating method.

It is preferable that the film tensioning element is free of a coating and/or hydrophobic. It is preferable that the film is formed as a liquid-tight fabric or has a fabric structure, and wherein the fabric comprises PA or a polyolefin.

It is preferable that to provide a film tensioning element and a scan head of a scanner combination having a scan head with a housing made of thermoplastic or thermoset, a film tensioning element having a film which is held stretched between tensioning rings, wherein the film is fabricated of a tough plastic which, at a contact pressure between the film and the scan head of between 1 and 10 N, has a coefficient of sliding or gliding friction μ_{G} of less than 1.5 or less than 1, with respect to the scan head.

It is preferable to provide a film tensioning element in combination with a scan head of a scanner having a scan head and a film tensioning element, wherein the film tensioning element is designed as a tensioning dam or as a coffer dam.

It is preferable to provide a method of using a film tensioning element in combination with a scan head of a scanner, comprising guiding the scan head along the film tensioning element, wherein the scan head is guided along the film tensioning element with the application of a contact pressure, and wherein the film tensioning element is used as a support for a uniform movement of the scan head. It is preferable that the contact pressure is at a level between 0 N and 10 N.

It is preferable to provide a method for producing a film tensioning element having two tensioning rings and a film including the steps of providing a mold comprising a patrix and a matrix, wherein the mold is in open position, introducing a film and bringing the film in contact with the patrix or the matrix by application of negative pressure or positive pressure, wherein the mold is then closed and tensioning rings are injected via injection-molding nozzles in the mold at points at which they are in contact with the film.

It is preferable that the patrix is placed under negative pressure and suctions in the film, and the tensioning rings are injected onto the film, one of the tensioning rings at the foot of the patrix and the other one of the tensioning rings at the head of the patrix.

It is preferable that the film extends over the head of the patrix during injection molding and, after demolding, is cut out at the tensioning ring adjacent thereto, forming a film tensioning element in the form of a conical section or optionally a hollow cylindrical element.

### BRIEF DESCRIPTION OF THE DRAWINGS

Further advantages, details and features result from the following description of an exemplary embodiment of the invention with reference to the drawing, in which:

FIG. 1 shows a schematic section through a mold for producing a film tensioning element according to the invention in one embodiment, in the open state;

FIG. 2 shows the illustration according to FIG. 1, but with the mold partially closed;

FIG. 3 shows the mold according to FIGS. 1 and 2 in the closed state, ready for injection of the rings;

FIG. 4 shows the mold according to FIGS. 1 to 3 in the opened state, after removal of the matrix; and

FIG. 5 shows a film tensioning element produced according to the invention, before and after punching out the end face.

### DETAILED DESCRIPTION

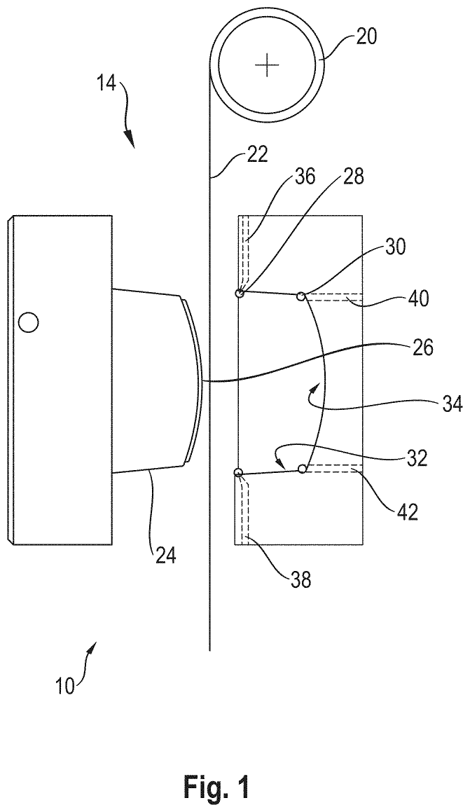

FIG. 1 shows a mold 10 for producing a film tensioning element 12 according to the invention. Basically, the mold 10 consists of a patrix 14 and a matrix 16, which can be moved towards each other in a known manner to close the mold.

A film web 18 is wound on a supply roll 20 and is passed as a film 22 between patrix 14 and matrix 16.

The film has a modulus of elasticity of less than 2 KN/mm². It is made of a tough plastic with a modulus of elasticity of more than 1 KN/mm². It can be made of polypropylene, polyamide or polyolefin and have a thickness suitable for the film tensioning element. This can be, for example, between 0.08 mm and 0.4 mm.

When the mold 10 is closed, the film 22 extends between the patrix 14 and the matrix 16 such that they are separated from the film 22. The patrix 14 has a substantially truncated cone shape, with a truncated cone 24 and an end face 26. In the illustrated exemplary embodiment, the end face 26 is convexly convex.

Outside the path of the film web 18, the matrix 16 and the patrix 14 abut each other. Thus, the mold 10 is closed. A gap is provided between the patrix 14 and the matrix 16 at the point where the film web 18 passes. The gap is adapted to the thickness of the film web and has, for example, a thickness of 0.1 mm.

In this respect, the film web 18 fills the mold 10 when the mold 10 is closed.

In addition, however, two annular spaces 28 and 30 are formed in the matrix 16. When the mold 10 is closed, the annular space 28 extends at the base of the truncated cone 24 of the patrix 14, i.e. at the end of the matrix 16 on the patrix side.

When the mold 10 is closed, the annular space 30 extends at the transition of the truncated cone 24 to the end face 26, in this respect at the transition of the wall 32 of the matrix 16 to its base face 34.

Both annular spaces 28 and 30 have a substantially circular cross-section of about one millimeter and extend in the course of the film web 18.

The annular space 28 is for forming the lip ring of the film tensioning element 12, and the annular space 30 is for forming the vestibular ring of the tensioning element 12.

Two injection molding channels 36 and 38 extend towards the annular space 28. Instead, it is also possible to implement only one of the injection molding channels 36 and 38, because the annular space 28 is also then filled with injection molding material. It is also possible to use the injection molding channel 36 as such aid, and to let the air displaced by the injection molding escape via the channel 38.

In contrast, the annular space 30 is provided for forming the vestibular ring of the film tensioning element 12. Channels 40 and 42 extend towards the annular space 30. Again, it is possible to use only one of the channels 40 and 42 for injection molding, and to use the other for the escape of the displaced air.

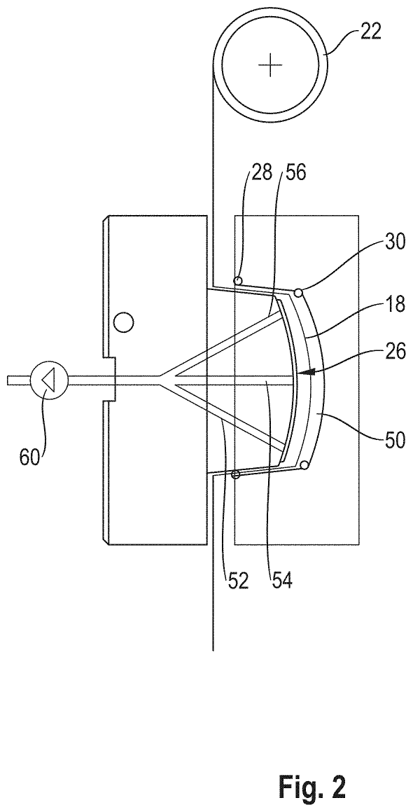

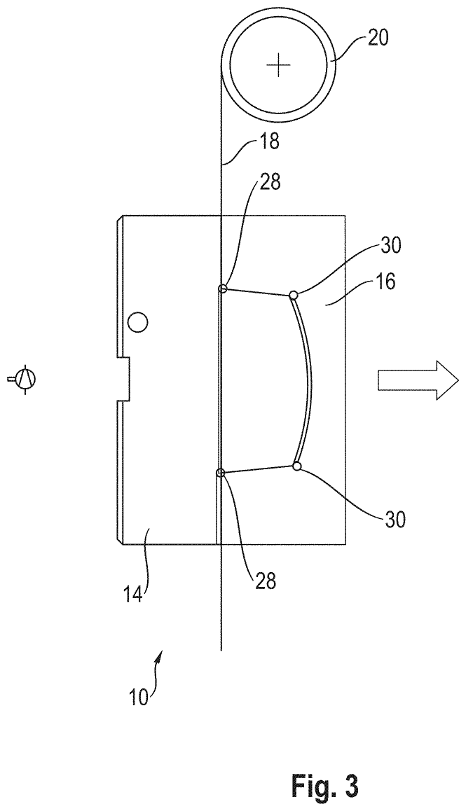

From the comparison of FIGS. 1 and 2, it can be seen that in an intermediate position between the open mold 10 according to FIG. 1 and the closed mold 10 according to FIG. 3, the film web 18 extends over the patrix 14 into the matrix 16. A cavity 50 remains between the patrix 14 and the matrix 16, in which the film web 18 runs loosely and unguided.

Suction channels 52, 54 and 56 are formed in the patrix 14, terminating at the end face 26, which are connected to a vacuum source 60. When the vacuum is turned on, the end face 26 sucks the film web 18 to lie against it. Therefore, when the mold 10 is closed, the film web 18 settles into the gap between the patrix 14 and the matrix 16 without wrinkles and smoothly. In addition to this, it is intended to keep the film web 18 under a certain, but low tension. This tension can be adjusted to the requirements within a wide range. It can be between 0.1 Newton and 10 Newton.

FIG. 3 shows the mold 10 in the closed state. Here, as in the other figures, the same reference signs correspond to the same or similar parts. The annular spaces 28 and 30 extend along the path of the film web 18, so that when the annular spaces 28 and 30 are injection molded, the injection molding material is injected directly onto the film 22.

The injection molding material may be the same material as the material of the film. The film tensioning element is produced by the injection molding together with the tensioning rings in one go.

After injection molding has taken place in the position shown in FIG. 3, the mold 10 is cooled down to such an extent that the injection molding material has solidified. For this purpose, cooling channels (not shown) can be formed in the mold 10, which enable cooling to take place within a few seconds.

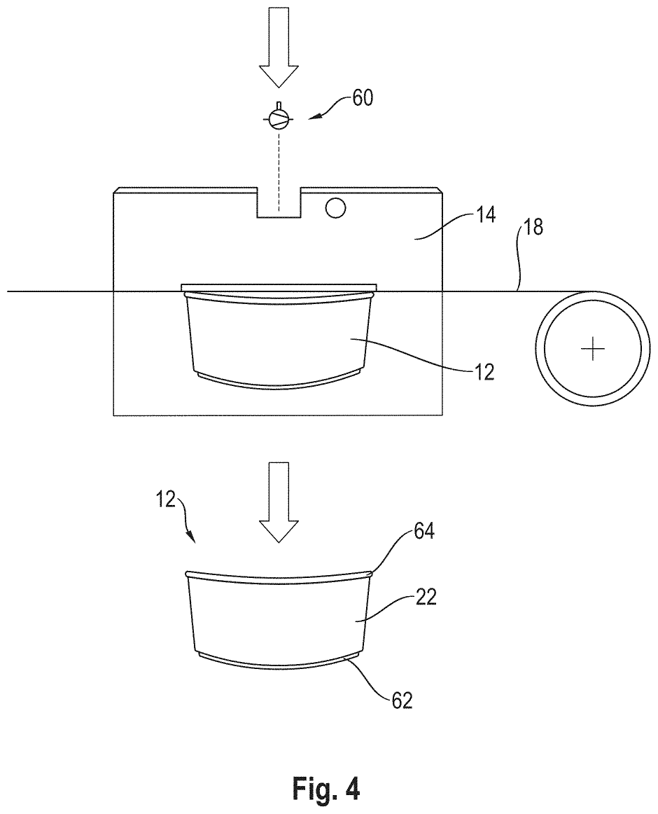

This is followed by demolding. This is shown in FIG. 4. The matrix 16 has already been removed and the finished film tensioning element 12 is exposed. Due to the truncated cone shape of the patrix 14, the film tensioning element 12 can be easily removed. This is preferably done by machine.

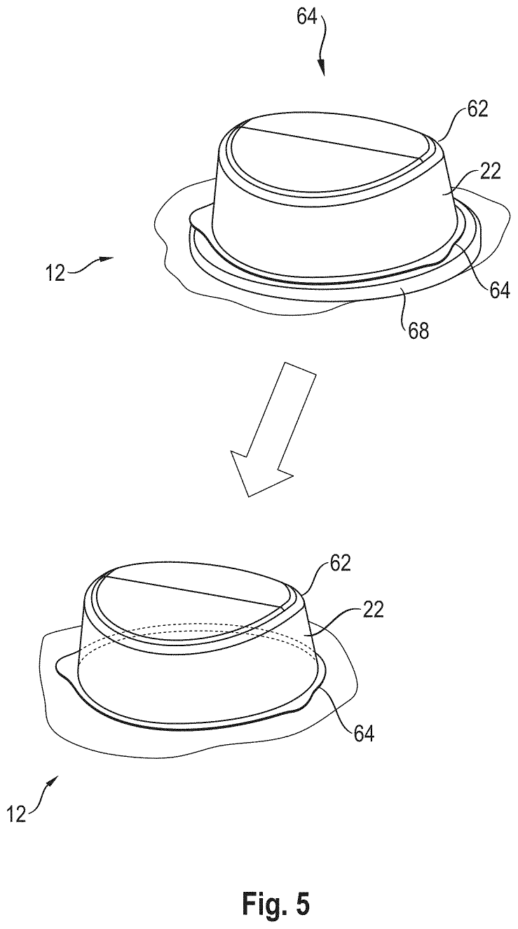

FIG. 5 above shows the film tensioning element 12 with the vestibular ring 62 and the lip ring 64. The film still exists on its face 66 but is no longer needed in use.

Furthermore, an excess of film 68 adjacent to the lip ring 64 is left over from the injection molding process.

These two surpluses are punched out and discarded.

This results in the shape of the film tensioning element 12 according to the invention, as shown in the lower part of FIG. 5.

The entire process of manufacturing the film tensioning element according to the invention can easily be carried out mechanically and automatically.

1. A film tensioning element for dental applications comprising
a film which extends between tensioning rings, the film having a modulus of elasticity of less than 2 KN/mm²,
wherein the film is fabricated of a plastic,
wherein the film tensioning element is produced together with the tensioning rings.

2. The film tensioning element according to claim 1,
wherein the plastic is a tough plastic having a modulus of elasticity of more than 1 KN/mm².

3. The film tensioning element according to claim 1,
wherein the plastic comprises a polyolefin, a linear polyester or a mixture thereof.

4. The film tensioning element according to claim 3,
wherein the polyolefin comprises polypropylene, polyamide or a mixture thereof and
wherein the linear polyester comprises polyethylene terephthalate (PET), polyethylene naphthalate (PEN), or a mixture thereof.

5. The film tensioning element according to claim 1,
wherein the tensioning rings are fabricated of the same plastic as the film and
wherein the tensioning rings are integral with the film.

6. The film tensioning element according to claim 1,
wherein the film has a coefficient of static friction μ_{H}<0.4 and a coefficient of gliding friction μ_{G}≤0.35.

7. The film tensioning element according to claim 6,
wherein the coefficient of static friction μ_{H} of the film and the coefficient of gliding friction μ_{G} of the film differ by less than 0.05.

8. The film tensioning element according to claim 1,
wherein the film tensioning element is designed as a tensioning dam or as a coffer dam and is intended for use in the mouth of a patient.

9. The film tensioning element according to claim 1,
wherein the film tensioning element is produced by a mold labelling or mold coating method.

10. The film tensioning element according to claim 1,
wherein the film tensioning element is free of a coating and/or hydrophobic.

11. The film tensioning element according to claim 1,
wherein the film is formed as a liquid-tight fabric or has a fabric structure, and
wherein the fabric comprises PA or a polyolefin.

12. A film tensioning element and a scan head of a scanner combination comprising
a scan head comprising a housing made of thermoplastic or thermoset,
a film tensioning element comprising a film which is held stretched between tensioning rings,
wherein the film is fabricated of a tough plastic which, at a contact pressure between the film and the scan head of between 1 and 10 N, has a coefficient of sliding friction μ_{G} of less than 1.5 or less than 1, with respect to the scan head.

13. A film tensioning element in combination with a scan head of a scanner comprising
a scan head and
a film tensioning element,
wherein the film tensioning element is designed as a tensioning dam or as a coffer dam.

14. A method of using a film tensioning element in combination with a scan head of a scanner, comprising
guiding the scan head along the film tensioning element,
wherein the scan head is guided along the film tensioning element with the application of a contact pressure, and
wherein the film tensioning element is used as a support for a uniform movement of the scan head.

15. The method according to claims 14,
wherein the contact pressure is at a level between 0 N and 10 N.

16. A method for producing a film tensioning element having two tensioning rings and a film comprising
providing a mold comprising a patrix and a matrix,
wherein the mold is in open position,
introducing a film and bringing the film in contact with the patrix or the matrix by application of negative pressure or positive pressure,
wherein the mold is then closed and tensioning rings are injected via injection-molding nozzles in the mold at points at which they are in contact with the film.

17. The method according to claim 16,
wherein the patrix is placed under negative pressure and suctions in the film, and
wherein the tensioning rings are injected onto the film, one of the tensioning rings at the foot of the patrix and the other one of the tensioning rings at the head of the patrix.

18. The method according to claim 16,
wherein the film extends over the head of the patrix during injection molding and, after demolding, is cut out at the tensioning ring adjacent thereto, forming a film tensioning element in the form of a conical section or optionally a hollow cylindrical element.
